(19) United States
(12) Patent Application Publication
(10) Pub. No.: US 2025/0383498 A1
(43) Pub. Date: Dec. 18, 2025

(54) OPTICAL COUPLING STRUCTURE

(71) Applicant: ELECTRONICS AND TELECOMMUNICATIONS RESEARCH INSTITUTE, Daejeon (KR)

(72) Inventors: Jin Tae KIM, Daejeon (KR); Jaegyu PARK, Daejeon (KR); Jung Jin JU, Daejeon (KR)

(73) Assignee: ELECTRONICS AND TELECOMMUNICATIONS RESEARCH INSTITUTE, Daejeon (KR)

(21) Appl. No.: 18/757,934

(22) Filed: Jun. 28, 2024

(30) Foreign Application Priority Data
Jun. 14, 2024 (KR) 10-2024-0077842

(51) Int. Cl. G02B 6/125; B82Y 20/00; G02B 6/12; G02B 6/122

(52) U.S. Cl. CPC G02B 6/125; B82Y 20/00; G02B 6/12007; G02B 6/1225

(57) ABSTRACT

Provided is an optical coupling structure. The optical coupling structure includes an optical waveguide arranged in one direction, a light-emitting device provided on the optical waveguide to generate light, and a resonator provided below the light-emitting device and provided at one side of the optical waveguide to transmit the light to the optical waveguide.

### CROSS-REFERENCE TO RELATED APPLICATIONS

This U.S. non-provisional patent application claims priority under 35 U.S.C. § 119 of Korean Patent Application No. 10-2024-0077842, filed on Jun. 14, 2024, the entire contents of which are hereby incorporated by reference.

### BACKGROUND

The present disclosure herein relates to an optical coupling structure, and more particularly, to an optical coupling structure including a light source containing a two-dimensional material and a planar optical waveguide.

In recent years, two-dimensional materials have attracted much attention due to their excellent optoelectronic properties and compatibility with various optical platforms. In particular, the van der Waals heterostructure, in which a single layer of heterogeneous two-dimensional materials are laminated, may operate as a light-emitting device by electrical or optical stimulation. The light source of the light-emitting device having the van der Waals heterostructure may also operate as a quantum light source. However, the design of optical structures for extracting light from the light-emitting device having the van der Waals heterostructure is not entirely satisfactory.

### SUMMARY

The present disclosure provides a light coupling structure that is capable of efficiently extracting light from a light-emitting device into an optical waveguide.

An embodiment of the inventive concept provides an optical coupling structure. In an embodiment, the optical coupling structure includes: an optical waveguide arranged in one direction; a light-emitting device provided on the optical waveguide to generate light; and a resonator provided below the light-emitting device and provided at one side of the optical waveguide to transmit the light to the optical waveguide.

In an embodiment, the resonator may include a disk resonator.

In an embodiment, the resonator may include a photonic crystal disk resonator.

In an embodiment, the resonator may include a photonic crystal ring resonator.

In an embodiment, the resonator may include a bar resonator.

In an embodiment, the optical waveguide may include: a first optical waveguide extending to one side of the resonator; and a second optical waveguide extending to the other side of the resonator.

In an embodiment, the resonator may include: external resonators provided outside both sides of the first optical waveguide and the second optical waveguide; and a central resonator provided between the first optical waveguide and the second optical waveguide and between the external resonators and smaller than each of the external resonators.

In an embodiment, the resonator may further include middle resonators provided between the external resonators and the central resonator and smaller than each of the external resonators and larger than the central resonator.

In an embodiment, the optical coupling structure may further include: a lower protective layer provided between the light-emitting device and the resonator and between the light-emitting device and the optical waveguide; and an upper protective layer provided on the light-emitting device.

In an embodiment, the optical coupling structure may further include a wave plate provided between the lower protective layer and the resonator.

In an embodiment of the inventive concept, an optical coupling structure includes: first and second optical waveguides arranged in one direction; a resonator provided at one side of the first and second optical waveguides or between the first and second optical waveguides; a lower protective layer provided on the first and second optical waveguides and the resonator; a light-emitting device comprising a lower metal oxide layer provided on the lower protective layer and an upper metal oxide layer provided on the lower metal oxide layer; and an upper protective layer provided on the light-emitting device.

In an embodiment, the resonator may include a disk resonator, a photonic crystal disk resonator, a photonic crystal ring resonator, or a bar resonator.

In an embodiment, the resonator may include: external resonators provided outside both sides of the first and second optical waveguides; middle resonators provided between the external resonators and smaller than each of the external resonators; and a central resonator provided between the middle resonators and smaller than each of the middle resonators.

In an embodiment, the middle resonators and the central resonator may be provided between the first and second optical waveguides.

In an embodiment, the optical coupling structure may further include a wave plate provided between the lower protective layer and the resonator.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIGS. 1A and 1B are perspective views illustrating an example of an optical coupling structure according to an embodiment of the inventive concept;

FIG. 2 is a cross-sectional view of FIGS. 1A and 1B;

FIGS. 3A and 3B are perspective views illustrating an example of the optical coupling structure according to an embodiment of the inventive concept;

FIG. 4 is a perspective view illustrating an example of the optical coupling structure according to an embodiment of the inventive concept;

FIG. 5 is a cross-sectional view of FIG. 4;

FIGS. 6A, 6B, 6C, and 6D are photographs illustrating an example of a resonator;

FIG. 6E is a photograph illustrating an example of the resonator of FIG. 1A:

FIG. 6F is a photograph illustrating an example of a general photonic crystal line resonator.

FIG. 7 is a perspective view illustrating an example of the optical coupling structure according to an embodiment of the inventive concept;

FIG. 8 is a perspective view illustrating an example of the optical coupling structure according to an embodiment of the inventive concept;

FIG. 9 is a cross-sectional view of FIG. 8.

FIG. 10 is a perspective view illustrating an example of an optical waveguide and resonators of FIG. 1A;

FIGS. 11A and 11B are perspective views illustrating an example of the optical coupling structure according to an embodiment of the inventive concept;

FIG. 12 is a cross-sectional view of FIG. 11A;

FIG. 13 is a perspective view illustrating an example of the optical waveguide and the resonator of FIG. 11A;

FIGS. 14A and 14B are perspective views illustrating an example of the optical coupling structure according to an embodiment of the inventive concept;

FIG. 15 is a perspective view illustrating an example of the optical coupling structure according to an embodiment of the inventive concept;

FIG. 16 is a perspective view illustrating an example of the optical coupling structure according to an embodiment of the inventive concept;

FIG. 17 is a cross-sectional view of FIG. 16;

FIG. 18 is a plan view illustrating an example of the optical waveguide and the resonator of FIG. 1A;

FIG. 19 is a perspective view illustrating an example of the optical coupling structure according to an embodiment of the inventive concept; and

FIG. 20 is a cross-sectional view of FIG. 19.

### DETAILED DESCRIPTION

Exemplary embodiments of technical ideas of the inventive concept will be described with reference to the accompanying drawings so as to sufficiently understand constitutions and effects of the inventive concept. The technical ideas of the inventive concept may, however, be embodied in different forms and should not be construed as limited to the embodiment set forth herein. Rather, these embodiments are provided so that this disclosure will be thorough and complete, and will fully convey the scope of the inventive concept to those skilled in the art. Further, the inventive concept is only defined by scopes of claims.

Like reference numerals refer to like elements throughout the specification. The embodiments in the detailed description will be described with exemplary block diagrams, perspective views, and/or cross-sectional views as ideal exemplary views of the inventive concept. In the figures, the dimensions of regions are exaggerated for effective description of the technical contents. Areas exemplified in the drawings have general properties and are used to illustrate a specific shape of a device. Thus, this should not be construed as limited to the scope of the inventive concept. Also, although various terms are used to describe various components in various embodiments of the inventive concept, the component are not limited to these terms. These terms are only used to distinguish one component from another component. The embodiments described and exemplified herein include complementary embodiments thereof.

In the following description, the technical terms are used only for explaining a specific exemplary embodiment while not limiting the inventive concept. In this specification, the terms of a singular form may comprise plural forms unless specifically mentioned. The meaning of ‘comprises’ and/or ‘comprising’ does not exclude other components besides a mentioned component.

Hereinafter, the present disclosure will be described in detail by explaining preferred embodiments of the technical ideas of the inventive concept with reference to the attached drawings.

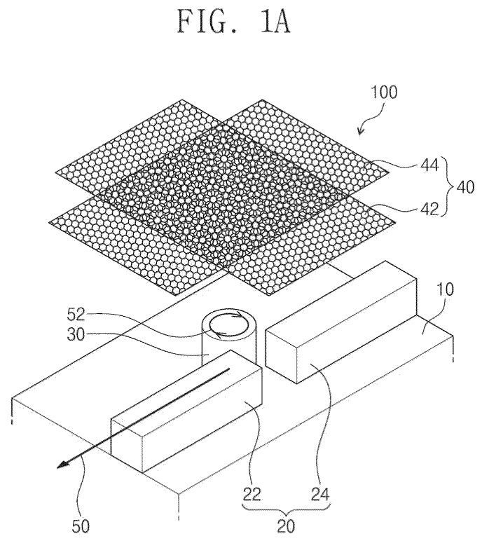

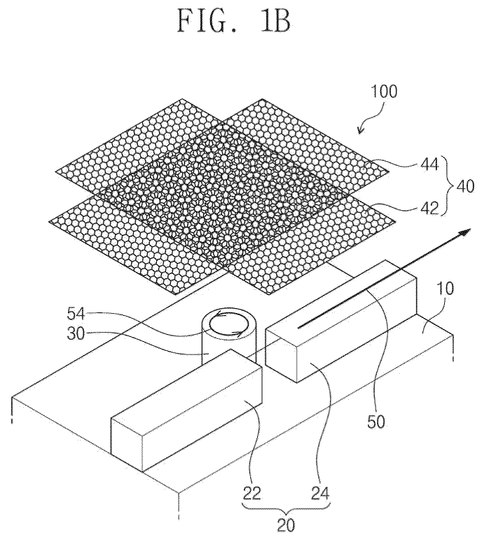

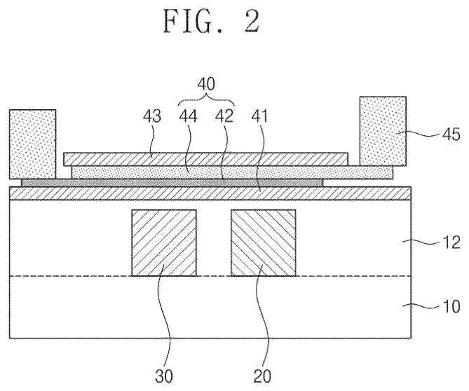

FIGS. 1A and 1B are perspective views illustrating an example of an optical coupling structure 100 according to an embodiment of the inventive concept. FIG. 2 is a cross-sectional view of FIGS. 1A and 1B.

Referring to FIGS. 1A, 1B, and 2, an optical coupling structure 100 according to an embodiment of the inventive concept may include a substrate 10, an optical waveguide 20, a resonator 30, and a light-emitting device 40.

The substrate 10 may include silicon oxide (SiO₂). The substrate 10 may include silicon, glass, or quartz, but an embodiment of the inventive concept is not limited thereto.

The optical waveguide 20 may be provided on the substrate 10. The optical waveguide 20 may be arranged in one direction. Alternatively, the optical waveguide 20 may extend in one direction. The optical waveguide 20 may have a refractive index greater than that of the substrate 10. For example, the optical waveguide 20 may include silicon (Si), silicon nitride (Si₃N₄), or silicon oxide. According to an embodiment, the optical waveguide 20 may include a first optical waveguide 22 and a second optical waveguide 24. The first optical waveguide 22 may be provided on one side of the substrate 10. The second optical waveguide 24 may be provided on the other side of the substrate 10. The first optical waveguide 22 and the second optical waveguide 24 may be aligned or arranged in one direction.

The resonator 30 may be provided at one side of the optical waveguide 20. The resonator 30 may be provided at one side between the first optical waveguide 22 and the second optical waveguide 24. The resonator 30 may have the same thickness as the optical waveguide 20. For example, the resonator 30 may include a disk resonator. The resonator 30 may have a circular shape in a planar perspective and a square shape in a vertical perspective. The resonator 30 may be provided below the light-emitting device 40. The resonator 30 may extract light 50 from the light-emitting device 40 to provide and/or transmit the light to the optical waveguide 20. The resonator 30 may have a refractive index that is the same as that of the optical waveguide 20. The resonator 30 may include silicon (Si), silicon nitride (Si₃N₄), or silicon oxide.

A clad layer 12 may be provided on the substrate 10 outside the resonator 30 and the optical waveguide 20. The clad layer 12 may have a refractive index that is the same as that of substrate 10. The clad layer 12 may include silicon oxide.

A lower protective layer 41 may be provided on the optical waveguide 20, the resonator 30, and the clad layer 12. The lower protective layer 41 may be a lower diffusion barrier layer. The lower protective layer 41 may include hexagonal boron nitride (hBN).

The light-emitting device 40 may be provided on the lower protective layer 41. The light-emitting device 40 may be provided on the resonator 30 and the optical waveguide 20. The light-emitting device 40 may generate light 50 using a bias voltage provided to electrodes 45 connected to both sides of the light-emitting device 40. For example, the light-emitting device 40 may generate light 50 having a circular polarization component. Alternatively, the light-emitting device 40 may generate light 50 having a linear polarization component, but this embodiment of the inventive concept is not limited thereto.

Referring to FIGS. 1A and 1B, when the light-emitting device 40 generates a right-handed circular polarization component 52, the resonator 30 may selectively transmit the light 50 having the right-handed circular polarization component 52 to the first optical waveguide 22. When the light-emitting device 40 generates a left-handed circular polarization component 54, the resonator 30 may selectively transmit the light 50 having the right-handed circular polarization component 52 to the second optical waveguide 24.

According to an embodiment, the light-emitting device 40 may include a two-dimensional material. For example, the light-emitting device 40 may have a van der Waals heterostructure. The light-emitting device 40 may include a lower metal oxide layer 42 and an upper metal oxide layer 44. The lower metal oxide layer 42 may include at least one of MoS₂, WS₂, MoSe₂, or WSe₂. An upper metal oxide layer 44 may be provided on the lower metal oxide layer 42. The upper metal oxide layer 44 may include at least one of MoS₂, WS₂, MoSe₂, or WSe₂. Each of the lower metal oxide layer 42 and the upper metal oxide layer 44 may include a laminated structure of MoS/WSe₂, MoSe₂/WSe₂, or WSe₂/WS₂. One of the electrodes 45 may be connected to the lower metal oxide layer 42, and the other may be connected to the upper metal oxide layer 44.

Referring to FIG. 2, an upper protective layer 43 may be provided on the upper metal oxide layer 44. The upper protective layer 43 may be an upper diffusion barrier layer. The upper protective layer 43 may include hexagonal boron nitride (hBN).

Therefore, the optical coupling structure 100 according to an embodiment of the inventive concept may use the resonator 30 provided at one side of the optical waveguide 20 below the light-emitting device 40 to efficiently extract or provide the light 50 of the light-emitting device 40 to the optical waveguide 20.

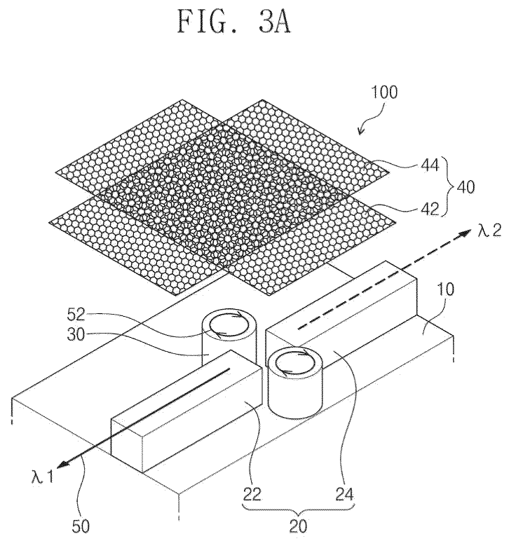

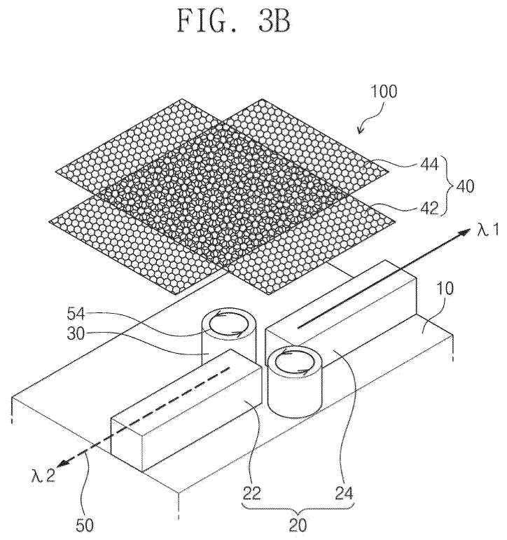

FIGS. 3A and 3B are perspective views illustrating an example of the optical coupling structure 100 according to an embodiment of the inventive concept.

Referring to FIGS. 3A and 3B, the resonators 30 having the optical coupling structure 100 according to an embodiment of the inventive concept may be provided at both sides of the optical waveguide 20. The resonators 30 may be arranged in a direction that intersects the direction of the optical waveguide 20. When the optical waveguide 20 is arranged in a first direction, the resonators 30 may be arranged in a second direction perpendicular to the first direction. The resonators 30 may transmit the light 50 to the first optical waveguide 22 and the second optical waveguide 24. The wavelengths of the light 50 transmitted to the first optical waveguide 22 and the second optical waveguide 24 may be different or the same.

Referring to FIG. 3A, the resonators 30 may transmit the light 50 having a right-handed circular polarization component 52 to the first optical waveguide 22 and the second optical waveguide 24. The light 50 in the first optical waveguide 22 may have a first wavelength Δ1. The light 50 in the second optical waveguide 24 may have a second wavelength λ2. For example, the first wavelength Δ1 and the second wavelength 22 may be different from each other or may be the same.

Referring to FIG. 3B, the resonators 30 may transmit the light 50 having the left-handed circular polarization component 54 to the first optical waveguide 22 and the second optical waveguide 24. The light 50 in the first optical waveguide 22 may have a second wavelength 22. The light 50 in the second optical waveguide 24 may have a first wavelength Δ1. The first wavelength Δ1 and the second wavelength 12 may be different from each other or may be the same.

The substrate 10 and the light-emitting device 40 may be configured the same as those in FIGS. 1A and 1B.

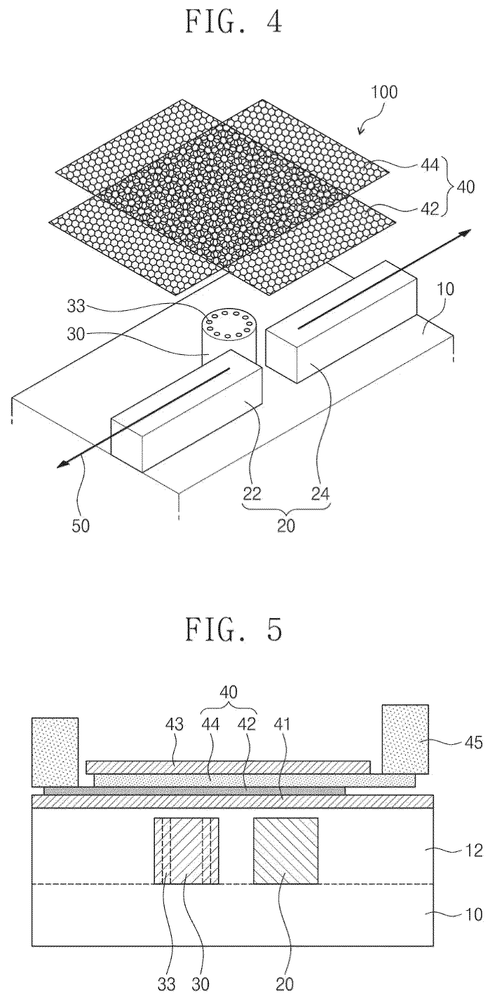

FIG. 4 is a perspective view illustrating an example of the optical coupling structure 100 according to an embodiment of the inventive concept. FIG. 5 is a cross-sectional view of FIG. 4.

Referring to FIGS. 4 and 5, the resonator 30 having the optical coupling structure 100 may include a photonic crystal disk resonator. According to an embodiment, the resonator 30 may have a plurality of edge holes 33. The edge holes 33 may be provided in an edge of the resonator 30. The edge holes 33 may be arranged circularly in a plan respective. The edge holes 33 may efficiently transmit the light 50 having the circular polarization component to the optical waveguide 20.

The substrate 10, the clad layer 12, the optical waveguide 20, the light-emitting device 40, the lower protective layer 41, and the upper protective layer 43 may have the same configurations as those in FIGS. 1A, 1B, and 2.

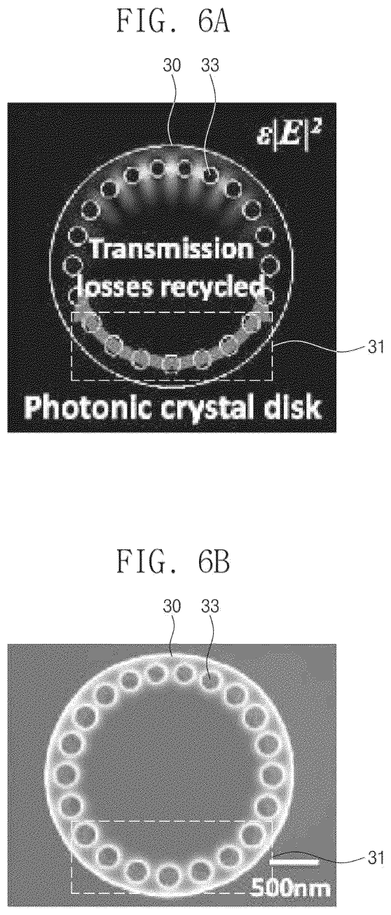

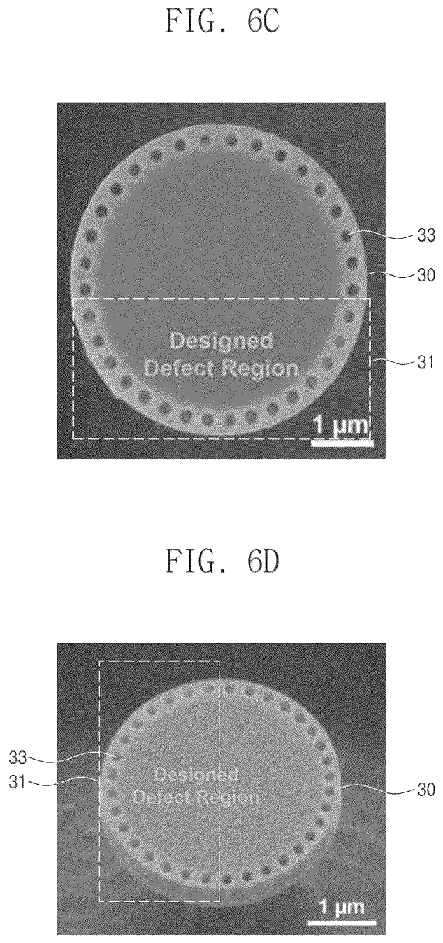

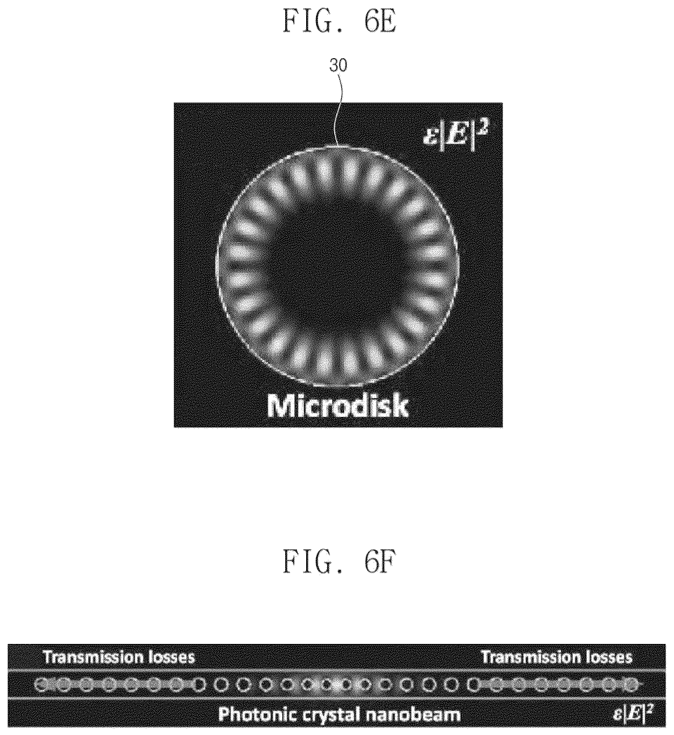

FIGS. 6A, 6B, 6C, and 6D illustrate an example of the resonator 30 of FIG. 4. FIG. 6E illustrates an example of the resonator 30 of FIG. 1A. FIG. 6F illustrates an example of a general photonic crystal line resonator.

Referring to FIGS. 6A, 6B, 6C, 6D, and 6E, each of resonators 30 such as a photonic crystal disk resonator and a disk resonator may have a circular shape in the planar respective. Among them, edge holes 33 of the photonic crystal disk resonator 30 may have the same size, unlike the holes of the general photonic crystal line resonator illustrated in FIG. 6F. The resonator 30 may have a defective area 31. The defective area 31 may be provided at one side of the edge of the resonator 30. The defective area 31 may deteriorate or improve transmission efficiency of light 50.

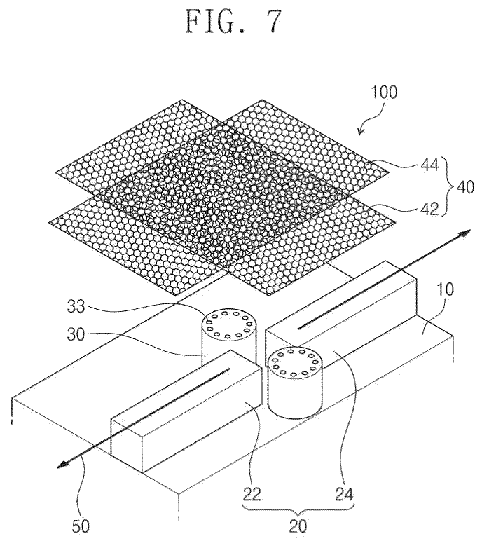

FIG. 7 is a perspective view illustrating an example of the optical coupling structure 100 according to an embodiment of the inventive concept.

Referring to FIG. 7, in the optical coupling structure 100 according to an embodiment of the inventive concept, the plurality of resonators 30 may be provided at both sides of the optical waveguide 20. The plurality of resonators 30 may improve the transmission efficiency of the light 50.

The substrate 10, the optical waveguide 20 and the light-emitting device 40 may be configured to be the same as those in FIGS. 1A and 1B.

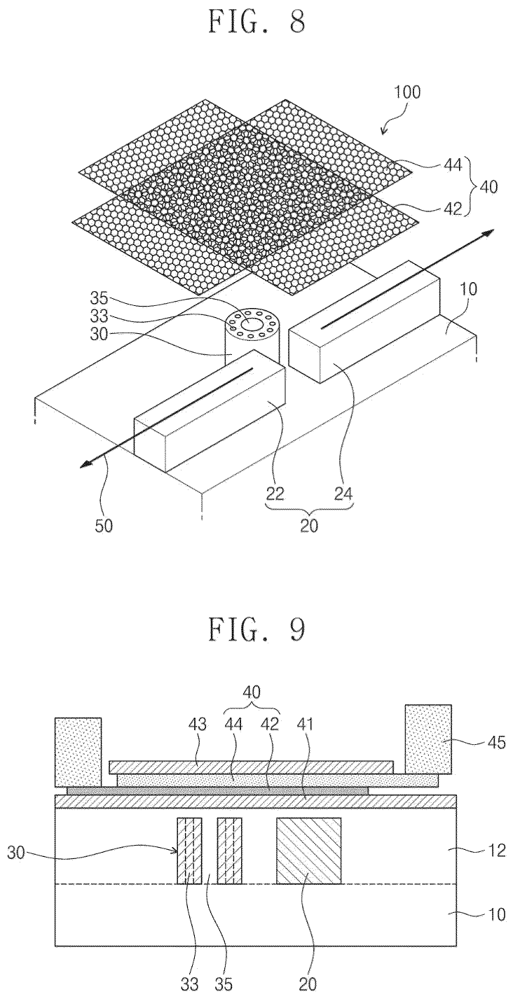

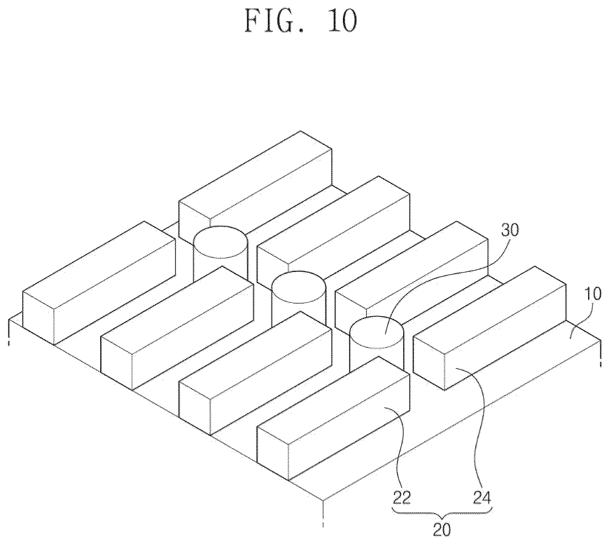

FIG. 8 is a perspective view illustrating an example of the optical coupling structure 100 according to an embodiment of the inventive concept. FIG. 9 is a cross-sectional view of FIG. 8.

Referring to FIGS. 8 and 9, the resonator 30 having the optical coupling structure 100 may include a photonic crystal ring resonator. According to an embodiment of the inventive concept, the resonator 30 may have a plurality of edge holes 33 and a center hole 35.

The edge holes 33 may be provided in an edge of the resonator 30. The edge holes 33 may be arranged circularly in a plan respective. The edge holes 33 may efficiently transmit the light 50 having the circular polarization component to the optical waveguide 20.

The central hole 35 may be provided at a center of the resonator 30. The center hole 35 may be provided between the edge holes 33. The center hole 35 may have the same direction as the edge holes 33. The center hole 35 may have a diameter greater than that of each of the edge holes 33. The center hole 35 may maximize the transmission efficiency of the light 50 having the circular polarization component.

The substrate 10, the clad layer 12, the optical waveguide 20, the light-emitting device 40, the lower protective layer 41, and the upper protective layer 43 may have the same configurations as those in FIGS. 1A, 1B, and 2.

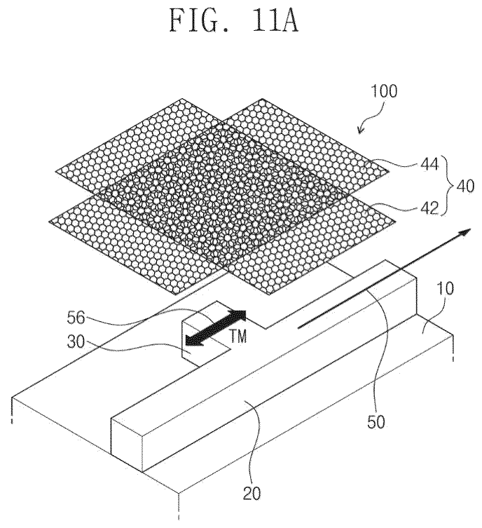

FIG. 10 illustrates an example of the optical waveguide and the resonators of FIG. 1A.

Referring to FIG. 10, the optical waveguides 20 and the resonators 30 may be arranged in the form of a two-dimensional array. The optical waveguides 20 and the resonators 30 may improve the light transmission efficiency of the light-emitting device 40. The resonators 30 may include a disk resonator, a photonic crystal disk resonator, or a photonic crystal ring resonator.

The substrate 10, the clad layer 12, the optical waveguide 20, the light-emitting device 40, the lower protective layer 41, and the upper protective layer 43 may have the same configurations as those in FIGS. 1A, 1B, and 2.

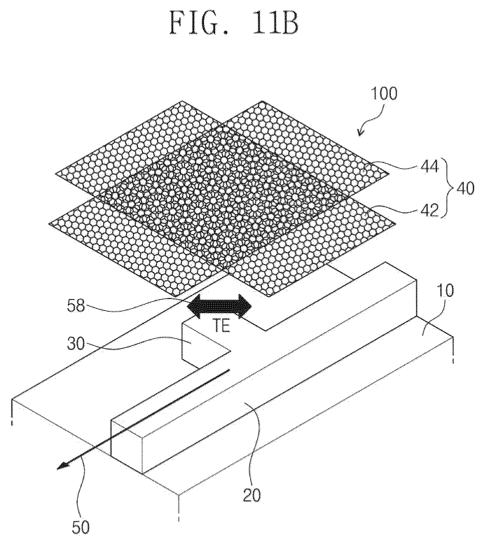

FIGS. 11A and 11B illustrate an example of the optical coupling structure 100 according to an embodiment of the inventive concept. FIG. 12 is a cross-sectional view of FIG. 11A.

Referring to FIGS. 11A, 11B, and 12, the resonator 30 having the optical coupling structure 100 according to an embodiment of the inventive concept may include a bar resonator. The resonator 30 may be connected to one side of the optical waveguide 20 in a direction crossing an extension direction of the optical waveguide 20. The resonator 30 may protrude to one side of the optical waveguide 20. Each of the optical waveguide 20 and the resonator 30 may have a T-shape in the planar respective. The resonator 30 may provide light 50 having the linear polarization component to the optical waveguide 20. The linear polarization component may include a vertical polarization component 58 (TE) and a horizontal polarization component 50 (TM).

Referring to FIG. 11A, when the light-emitting device 40 generates the light 50 having the horizontal polarization component 56, the resonator 30 may receive the light 50 having the horizontal polarization component 56 from the light-emitting device 40 to selectively provide the light 50 in one direction (e.g., forward direction) of the optical waveguide 20.

Referring to FIG. 11B, when the light-emitting device 40 generates the light 50 having the vertical polarization component 58, the resonator 30 may receive the light 50 having the vertical polarization component 58 from the light-emitting device 40 to selectively provide the light in the other direction (e.g., reverse direction) of the optical waveguide 20.

The substrate 10, the clad layer 12, the optical waveguide 20, the light-emitting device 40, the lower protective layer 41, and the upper protective layer 43 may have the same configurations as those in FIGS. 1A, 1B, and 2.

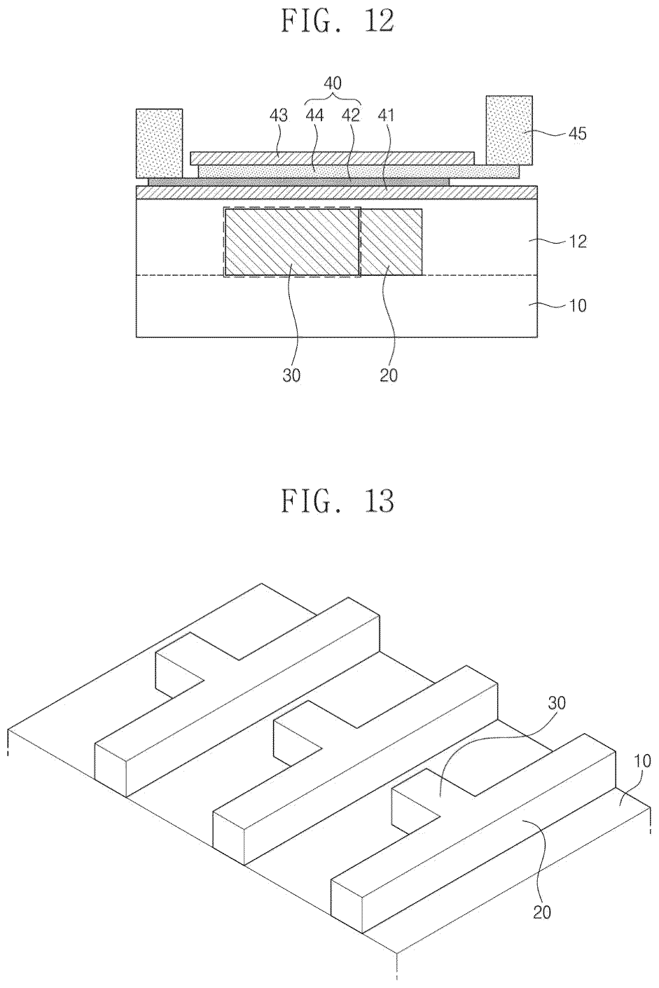

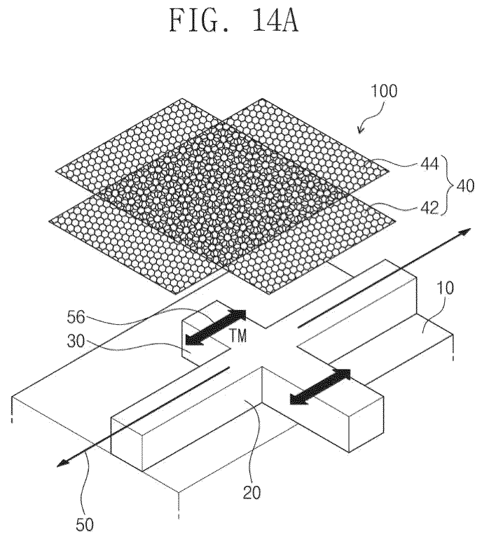

FIG. 13 illustrates an example of the optical waveguide 20 and the resonator 30 of FIG. 11A.

Referring to FIG. 13, the optical waveguide 20 and the resonator 30 may be arranged in the form of a two-dimensional array to improve the light transmission efficiency of the light-emitting device 40.

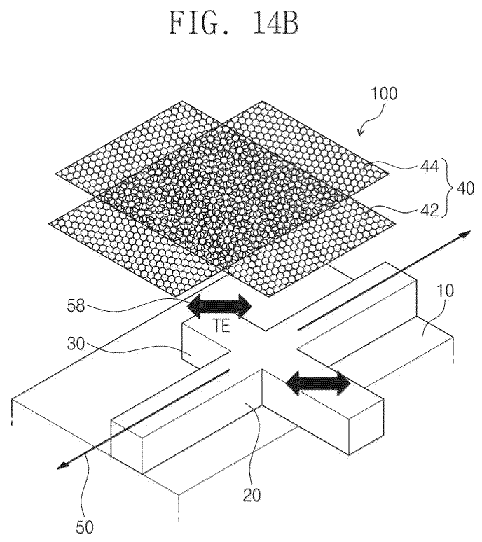

FIGS. 14A and 14B illustrate an example of the optical coupling structure 100 according to an embodiment of the inventive concept.

Referring to FIGS. 14A and 14B, the resonators 30 having the optical coupling structure 100 according to an embodiment of the inventive concept may include a plurality of bar resonators connected to both sidewalls of the optical waveguide 20. According to an embodiment, the optical waveguide 20 and the resonators 30 may have a cross shape in the planar respective. The resonators 30 may provide and/or transmit the light 50 having the linear polarization component to the optical waveguide 20. For example, the resonators 30 may provide the light 50 having the horizontal polarization component 56 in both directions of the optical waveguide 20. Resonators 30 may provide the light 50 having the vertical polarization component 58 in both the directions of the optical waveguide 20.

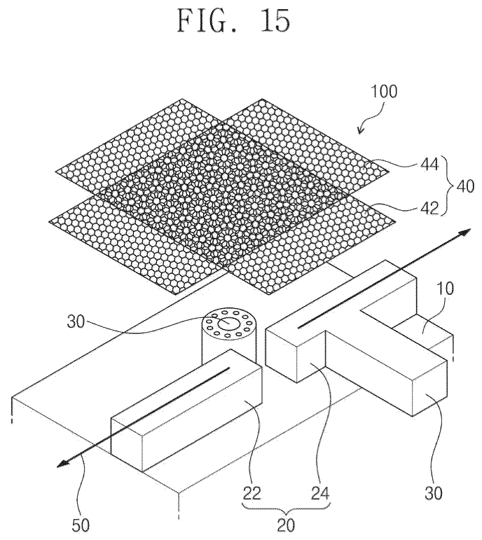

FIG. 15 illustrates an example of the optical coupling structure 100 according to an embodiment of the inventive concept.

Referring to FIG. 15, the resonators 30 having the optical coupling structure 100 according to an embodiment of the inventive concept may have different types. According to an embodiment, one of the resonators 30 may include a photonic crystal ring resonator, and the other may include a bar resonator. One of the resonators 30, i.e., the photonic crystal ring resonator may be provided at one side of the first optical waveguide 22 and the second optical waveguide 24, and the other of the resonators 30, i.e., the bar resonator may be provided at the other side of the second optical waveguide 24.

The substrate 10, the optical waveguide 20 and the light-emitting device 40 may be configured to be the same as those in FIG. 1A.

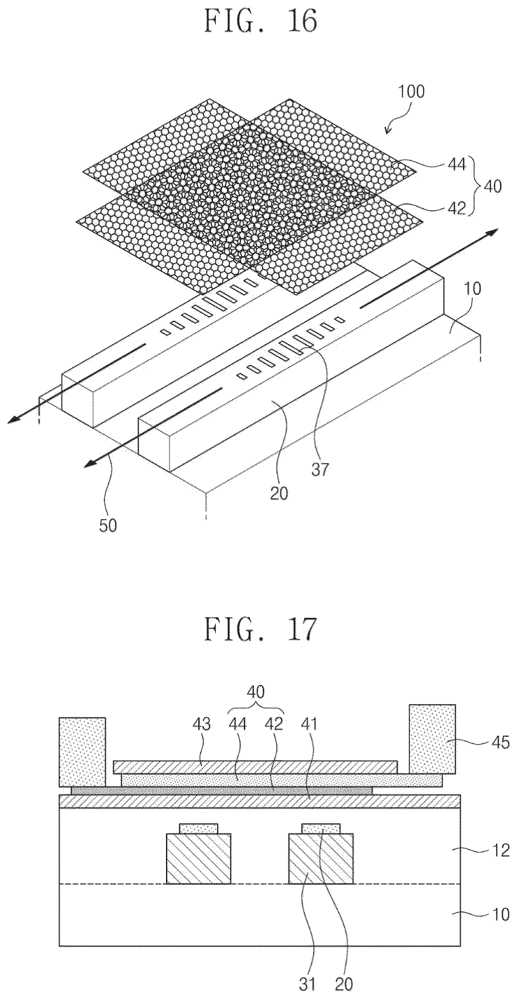

FIG. 16 illustrates an example of the optical coupling structure 100 according to an embodiment of the inventive concept. FIG. 17 is a cross-sectional view of FIG. 16.

Referring to FIGS. 16 and 17, the optical coupling structure 100 according to an embodiment of the inventive concept may further include a Yagi-Uda antenna 37. The Yagi-Uda antenna 37 may be provided on the optical waveguides 20. The Yagi-Uda antenna 37 may replace the resonator 30 of FIG. 1. The Yagi-Uda antenna 37 may transmit the light 50 of the light-emitting device 40 to both sides of the optical waveguides 20. The Yagi-Uda antenna 37 may include a plurality of patterns. According to an embodiment, each of the patterns of the Yagi-Uda antenna 37 may have a smaller length as it extends in both the directions of the optical waveguide 20. For example, the Yagi-Uda antenna 37 may include silicon, silicon nitride, or silicon oxide. The plurality of optical waveguides 20 may be arranged in parallel to each other.

The substrate 10, the clad layer 12, the light-emitting device 40, the lower protective layer 41, and the upper protective layer 43 may be configured to be the same as those in FIGS. 1A, 1B, and 2.

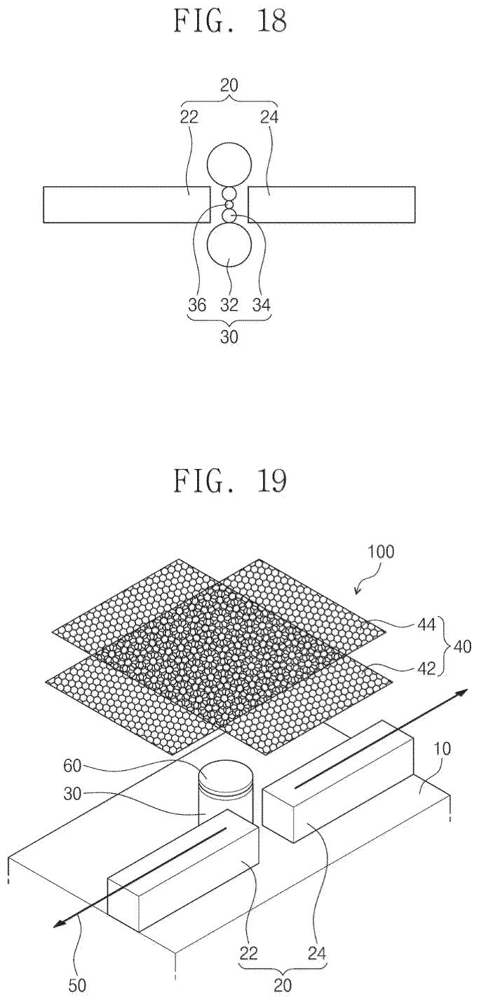

FIG. 18 illustrates an example of the optical waveguide 20 and the resonator 30 of FIG. 1A.

Referring to FIG. 18, the resonator 30 may be provided between the first optical waveguide 22 and the second optical waveguide 24. According to an embodiment, the resonator 30 may include external resonators 32, middle resonators 34, and a central resonator 36.

The external resonators 32 may be provided between the first optical waveguide 22 and the second optical waveguide 24. The external resonators 32 may be provided outside the first optical waveguide 22 and the second optical waveguide 24. Each of the external resonators 32 may have a circular shape in the planar respective.

The middle resonators 34 may be provided between the external resonators 32. The middle resonators 34 may be provided between the first optical waveguide 22 and the second optical waveguide 24. Each of the middle resonators 34 may be smaller than each of the external resonators 32. The middle resonators 34 may have the same shape as the external resonators 32. For example, each of the middle resonators 34 may have a diameter less than that of each of the external resonators 32.

The central resonator 36 may be provided between the middle resonators 34. The central resonator 36 may be aligned at the center of the first optical waveguide 22 and the second optical waveguide 24. The central resonator 36 may be smaller than each of the middle resonators 34. The central resonator 36 may have the same shape as the external resonators 32 and the middle resonators 34. The central resonator 36 may have a diameter less than that of each of the middle resonators 34.

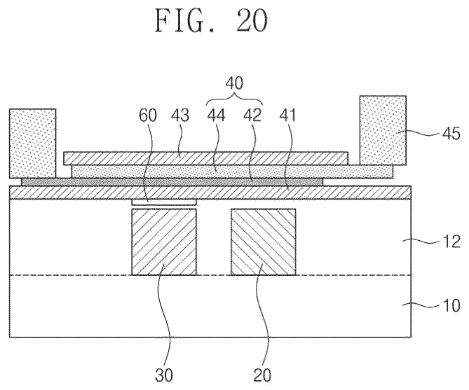

FIG. 19 illustrates an example of the optical coupling structure 100 according to an embodiment of the inventive concept. FIG. 20 is a cross-sectional view of FIG. 19.

Referring to FIGS. 19 and 20, the light coupling structure 100 according to an embodiment of the inventive concept may further include a wave plate 60. The wave plate 60 may be provided between the resonator 30 and the light-emitting device 40. The wave plate 60 may include a quarter wave plate. When the light-emitting device 40 generates the light 50 having the linear polarization component, the wave plate 60 may convert the linear polarization component of the light 50 into the circular polarization component to transmits the light 50 to the optical waveguide 20.

The optical coupling structure according to the embodiment of the inventive concept may efficiently extract the light from the light-emitting device into the optical waveguide by using the resonator provided at one side of the optical waveguide below the light-emitting device.

Although the embodiment of the inventive concept is described with reference to the accompanying drawings, those with ordinary skill in the technical field of the inventive concept pertains will be understood that the inventive concept can be carried out in other specific forms without changing the technical idea or essential features. Thus, the above-disclosed embodiments are to be considered illustrative and not restrictive.

What is claimed is:

1. An optical coupling structure comprising:
an optical waveguide arranged in one direction;
a light-emitting device provided on the optical waveguide to generate light; and
a resonator provided below the light-emitting device and provided at one side of the optical waveguide to transmit the light to the optical waveguide.

2. The optical coupling structure of claim 1, wherein the resonator comprises a disk resonator.

3. The optical coupling structure of claim 1, wherein the resonator comprises a photonic crystal disk resonator.

4. The optical coupling structure of claim 1, wherein the resonator comprises a photonic crystal ring resonator.

5. The optical coupling structure of claim 1, wherein the resonator comprises a bar resonator.

6. The optical coupling structure of claim 1, wherein the optical waveguide comprises:
a first optical waveguide extending to one side of the resonator; and
a second optical waveguide extending to the other side of the resonator.

7. The optical coupling structure of claim 6, wherein the resonator comprises:
external resonators provided outside both sides of the first optical waveguide and the second optical waveguide; and
a central resonator provided between the first optical waveguide and the second optical waveguide and between the external resonators and smaller than each of the external resonators.

8. The optical coupling structure of claim 7, wherein the resonator further comprises middle resonators provided between the external resonators and the central resonator and smaller than each of the external resonators and larger than the central resonator.

9. The optical coupling structure of claim 1, further comprising:
a lower protective layer provided between the light-emitting device and the resonator and between the light-emitting device and the optical waveguide; and
an upper protective layer provided on the light-emitting device.

10. The optical coupling structure of claim 9, further comprising a wave plate provided between the lower protective layer and the resonator.

11. An optical coupling structure comprising:
first and second optical waveguides arranged in one direction;
a resonator provided at one side of the first and second optical waveguides or between the first and second optical waveguides;
a lower protective layer provided on the first and second optical waveguides and the resonator;
a light-emitting device comprising a lower metal oxide layer provided on the lower protective layer and an upper metal oxide layer provided on the lower metal oxide layer; and
an upper protective layer provided on the light-emitting device.

12. The optical coupling structure of claim 11, wherein the resonator comprises a disk resonator, a photonic crystal disk resonator, a photonic crystal ring resonator, or a bar resonator.

13. The optical coupling structure of claim 11, wherein the resonator comprises:
external resonators provided outside both sides of the first and second optical waveguides;
middle resonators provided between the external resonators and smaller than each of the external resonators; and
a central resonator provided between the middle resonators and smaller than each of the middle resonators.

14. The optical coupling structure of claim 13, wherein the middle resonators and the central resonator are provided between the first and second optical waveguides.

15. The optical coupling structure of claim 11, further comprising a wave plate provided between the lower protective layer and the resonator.
